(19) United States
(12) Patent Application Publication
(10) Pub. No.: US 2024/0360982 A1
(43) Pub. Date: Oct. 31, 2024

(54) ILLUMINATION SYSTEM

(71) Applicant: Japan Display Inc., Tokyo (JP)

(72) Inventors: Kazunori YAMAGUCHI, Tokyo (JP); Chiehan CHIEN, Tokyo (JP); Gang SHAO, Tokyo (JP)

(21) Appl. No.: 18/771,712

(22) Filed: Jul. 12, 2024

Related U.S. Application Data
(63) Continuation of application No. PCT/JP2022/046777, filed on Dec. 20, 2022.

(30) Foreign Application Priority Data
Jan. 27, 2022 (JP) 2022-011279

(51) Int. Cl. F21V 14/00; F21Y 113/00

(52) U.S. Cl. CPC F21V 14/00; F21Y 2113/00

(57) ABSTRACT

According to an aspect, an illumination system includes a plurality of illumination devices each having a light adjustment function. Each of the illumination devices has a first mode in which all of the illumination devices are not subject to light adjustment control, and a second mode in which another illumination device of the illumination devices is subject to the light adjustment control. In the second mode, the illumination device is controlled to be in a light adjustment state different from a light adjustment state in the first mode.

### CROSS-REFERENCE TO RELATED APPLICATION

This application claims the benefit of priority from Japanese Patent Application No. 2022-011279 filed on Jan. 27, 2022 and International Patent Application No. PCT/JP2022/046777 filed on Dec. 20, 2022, the entire contents of which are incorporated herein by reference.

### BACKGROUND

### 1. Technical Field

What is disclosed herein relates to an illumination system.

### 2. Description of the Related Art

In a conventional illumination instrument, a light source such as an LED is combined with a thin lens provided with a prism pattern, and the distance between the light source and the thin lens is changed to change a light distribution angle. For example, an illumination instrument is disclosed in which the front of a transparent light bulb is covered by a liquid crystal light adjustment element, and the transmittance of a liquid crystal layer is changed to switch between directly reaching light and scattering light.

In an illumination system including a plurality of illumination devices each having various light adjustment functions such as functions of adjusting the light emission intensity and the light emission color (white balance) in addition to the distribution angle, when each of the illumination devices is subject to light adjustment control and the light adjustment control of the illumination device is individually performed, effects of the light adjustment control of the illumination device subject to the light adjustment control may be difficult to recognize due to interference with light emitted from any illumination device not subject to the light adjustment control.

For the foregoing reasons, there is a need for an illumination system with which effects of light adjustment control of an illumination device subject to the light adjustment control are easy to recognize.

### SUMMARY

According to an aspect, an illumination system includes a plurality of illumination devices each having a light adjustment function. Each of the illumination devices has a first mode in which all of the illumination devices are not subject to light adjustment control, and a second mode in which another illumination device of the illumination devices is subject to the light adjustment control. In the second mode, the illumination device is controlled to be in a light adjustment state different from a light adjustment state in the first mode.

According to an aspect, an illumination system includes: a plurality of illumination devices each having a light adjustment function; and a control device configured to perform light adjustment control of the illumination devices. Each of the illumination devices has a first mode in which all of the illumination devices are not subject to the light adjustment control, and a second mode in which another illumination device of the illumination devices is subject to the light adjustment control. Each of the illumination devices is lit in the first mode. When at least one of the illumination devices is subject to the light adjustment control and the light adjustment control of the at least one of the illumination devices is performed, the control device repeatedly alternates, at predetermined intervals, a light adjustment control period in which the light adjustment control is performed and a turn-off period in which the at least one of the illumination devices subject to the light adjustment control is not lit.

According to an aspect, an illumination system includes: a plurality of illumination devices each having a light adjustment function; and a control device configured to perform light adjustment control of the illumination devices. Each of the illumination devices has a first mode in which all of the illumination devices are not subject to the light adjustment control, and a second mode in which another illumination device of the illumination devices is subject to the light adjustment control. Each of the illumination devices is lit in the first mode. When at least one of the illumination devices is subject to the light adjustment control and the light adjustment control of the at least one of the illumination devices is performed, the control device repeatedly alternates, at predetermined intervals, a light adjustment control period in which the light adjustment control is performed and a dimming period in which the at least one of the illumination devices subject to the light adjustment control is dimmed relative to the light adjustment control period.

According to an aspect, an illumination system includes: a plurality of illumination devices each having a light adjustment function; and a control device configured to perform light adjustment control of the illumination devices. Each of the illumination devices has a first mode in which all of the illumination devices are not subject to the light adjustment control, and a second mode in which another illumination device of the illumination devices is subject to the light adjustment control. Each of the illumination devices is lit in a first light emission color in the first mode. When at least one of the illumination devices is subject to the light adjustment control and the light adjustment control of the at least one of the illumination devices is performed, the control device causes the at least one of the illumination devices to be lit in a second light emission color different from the first light emission color.

### BRIEF DESCRIPTION OF THE DRAWINGS

FIG. 1A is a side view illustrating an example of an illumination device according to an embodiment;

FIG. 1B is a perspective view illustrating an example of a light distribution device according to the embodiment;

FIG. 2 is a schematic plan view of a first substrate when viewed in a Dz direction;

FIG. 3 is a schematic plan view of a second substrate when viewed in the Dz direction;

FIG. 4 is a fluoroscopic diagram of a liquid crystal cell in which the first substrate and the second substrate stacked in the Dz direction;

FIG. 5 is a sectional view along line A-A′ illustrated in FIG. 4;

FIG. 6A is a diagram illustrating a rubbing direction of an alignment film of the first substrate;

FIG. 6B is a diagram illustrating a rubbing direction of an alignment film of the second substrate;

FIG. 7 is a conceptual diagram for conceptually describing the distribution angle of light from the illumination device according to the embodiment;

FIG. 8 is a schematic diagram illustrating an example of the configuration of an illumination system according to the embodiment;

FIG. 9 is an external view illustrating an example of a control device according to the embodiment;

FIG. 10 is a conceptual diagram illustrating an example of a detection region of a touch sensor;

FIG. 11 is a diagram illustrating an example of a control block configuration of the control device according to the embodiment;

FIG. 12 is a conceptual diagram illustrating an example of a light adjustment control data adjustment method in the embodiment;

FIG. 13A is a conceptual diagram illustrating a first display example of the control device according to the embodiment for adjusting the distribution angle;

FIG. 13B is a conceptual diagram illustrating a second display example of the control device according to the embodiment for adjusting the distribution angle;

FIG. 13C is a conceptual diagram illustrating a display example of the control device according to the embodiment for adjusting light emission intensity;

FIG. 14 is a diagram illustrating an example of a control block configuration of the illumination device according to the embodiment;

FIG. 15 is a flowchart illustrating an example of light adjustment control processing by the control device according to the embodiment;

FIG. 16 is a flowchart illustrating an example of light adjustment control processing by the illumination device according to the embodiment;

FIG. 17A is a conceptual diagram for describing operation of each illumination device in light adjustment control of the illumination system according to the embodiment;

FIG. 17B is a conceptual diagram for describing operation of each illumination device in the light adjustment control of the illumination system according to the embodiment;

FIG. 17C is a conceptual diagram for describing operation of each illumination device in the light adjustment control of the illumination system according to the embodiment;

FIG. 18A is a diagram illustrating an example of a light adjustment assistance control state of the illumination system according to the embodiment;

FIG. 18B is a diagram illustrating an example of the light adjustment assistance control state of the illumination system according to the embodiment;

FIG. 18C is a diagram illustrating an example of the light adjustment assistance control state of the illumination system according to the embodiment;

FIG. 18D is a diagram illustrating an example of the light adjustment assistance control state of the illumination system according to the embodiment;

FIG. 18E is a diagram illustrating an example of the light adjustment assistance control state of the illumination system according to the embodiment;

FIG. 18F is a diagram illustrating an example of the light adjustment assistance control state of the illumination system according to the embodiment;

FIG. 19 is a flowchart illustrating an example of light adjustment control processing by the control device according to a first modification of the embodiment;

FIG. 20A is a conceptual diagram for describing operation of each illumination device in the light adjustment control of an illumination system according to a second modification of the embodiment; and

FIG. 20B is a conceptual diagram for describing operation of each illumination device in the light adjustment control of the illumination system according to the second modification of the embodiment.

### DETAILED DESCRIPTION

Aspects (embodiments) of the present disclosure will be described below in detail with reference to the accompanying drawings. Contents described below in the embodiments do not limit the present disclosure. Components described below include those that could be easily thought of by the skilled person in the art and those identical in effect. Components described below may be combined as appropriate. What is disclosed herein is merely exemplary, and any modification that could be easily thought of by the skilled person in the art as appropriate without departing from the gist of the disclosure is contained in the scope of the present disclosure. For clearer description, the drawings are schematically illustrated for the width, thickness, shape, and the like of each component as compared to an actual aspect in some cases, but the drawings are merely exemplary and do not limit interpretation of the present disclosure. In the present specification and drawings, any element same as that already described with reference to an already described drawing is denoted by the same reference sign, and detailed description thereof is omitted as appropriate in some cases.

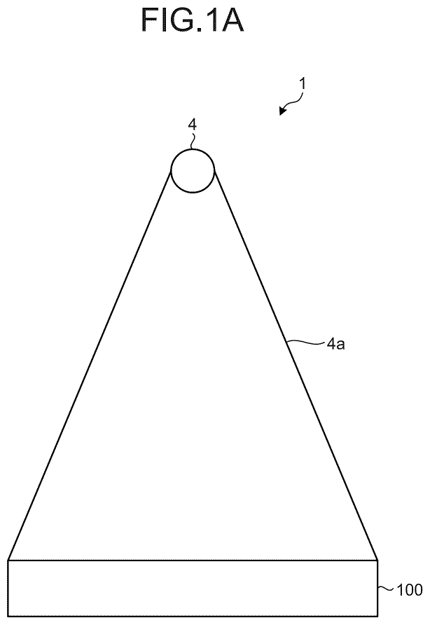

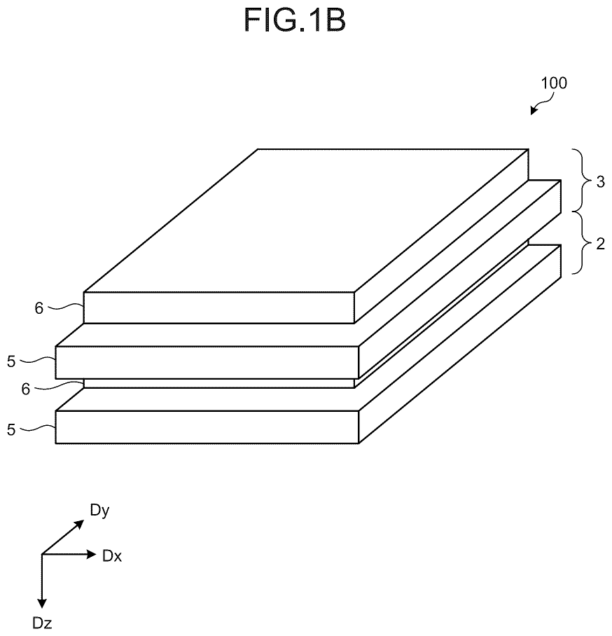

FIG. 1A is a side view illustrating an example of an illumination device according to an embodiment. This illumination device 1 according to the embodiment is an illumination instrument having what is called a light adjustment function. As illustrated in FIG. 1A, the illumination device 1 includes a light source 4, a reflector 4a, and a light distribution device 100.

The light source 4 includes, for example, a light emitting diode (LED). In the present disclosure, the light source 4 is capable of adjusting the intensity (hereinafter also referred to as “light emission intensity”) of light emitted from the illumination device 1. The reflector 4a is a component through which light from the light source 4 is condensed to the light distribution device 100.

The light source 4 may include LEDs in three colors of red (R), green (G), and blue (B), for example. The light source 4 may be capable of adjusting the white balance and emission color of light emitted from the illumination device 1.

FIG. 1B is a perspective view illustrating an example of the light distribution device according to the embodiment. As illustrated in FIG. 1B, the light distribution device 100 includes a first liquid crystal cell 2 and a second liquid crystal cell 3. In the present disclosure, the light distribution device 100 is capable of adjusting the distribution angle of light emitted from the illumination device 1.

In FIG. 1B, a Dz direction represents the irradiation direction of light from the light source 4 and the reflector 4a. The light distribution device 100 is formed by stacking the first liquid crystal cell 2 and the second liquid crystal cell 3 in the Dz direction. In FIG. 1, one direction in a plane parallel to a stacking plane of the first liquid crystal cell 2 and the second liquid crystal cell 3 orthogonal to the Dz direction is defined as a Dx direction, and a direction orthogonal to the Dx direction and the Dz direction is defined as a Dy direction.

The first liquid crystal cell 2 and the second liquid crystal cell 3 have the same configuration. In the present embodiment, the first liquid crystal cell 2 is a liquid crystal cell for p wave polarization. The second liquid crystal cell 3 is a liquid crystal cell for s wave polarization. Alternatively, the first liquid crystal cell 2 may be a liquid crystal cell for s wave polarization, and the second liquid crystal cell 3 may be a liquid crystal cell for p wave polarization. It is only needed that one of the first liquid crystal cell 2 and the second liquid crystal cell 3 is a liquid crystal cell for p wave polarization and the other is a liquid crystal cell for s wave polarization.

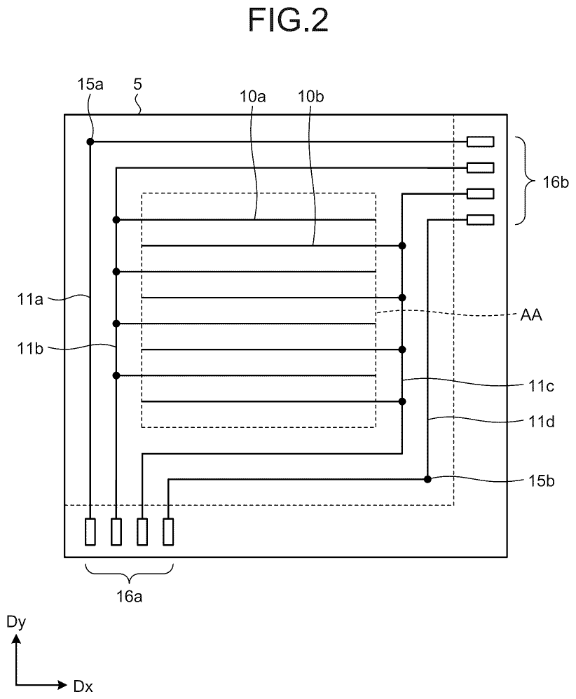

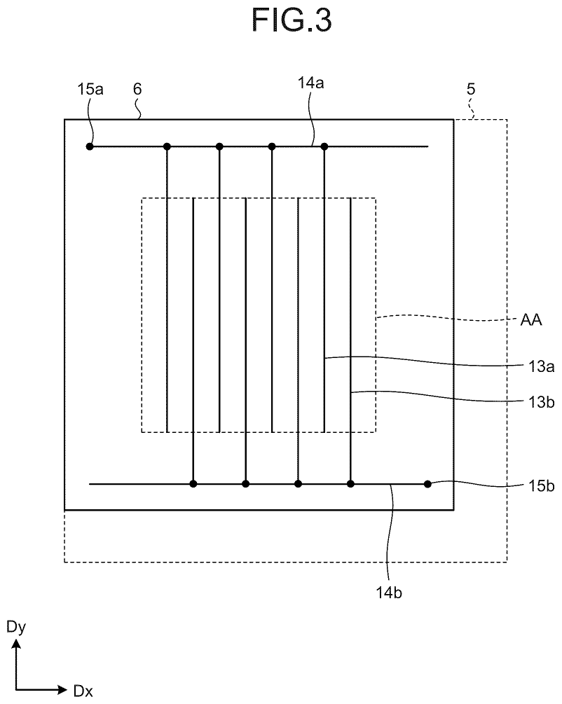

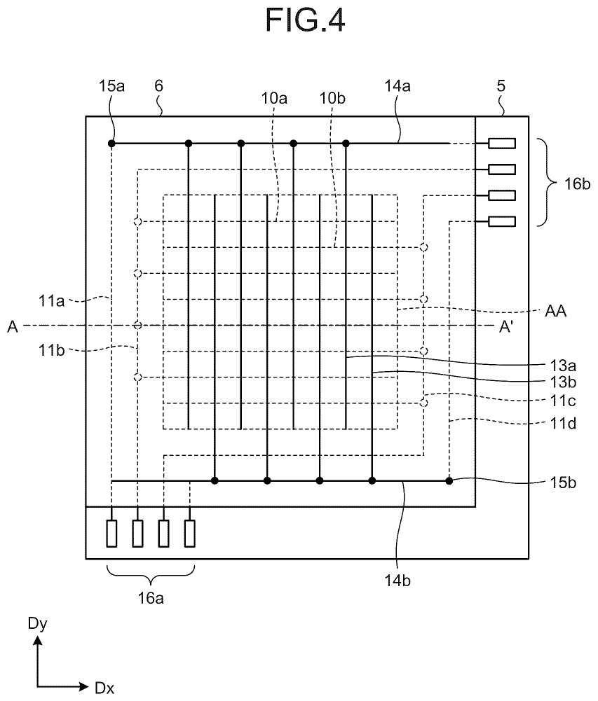

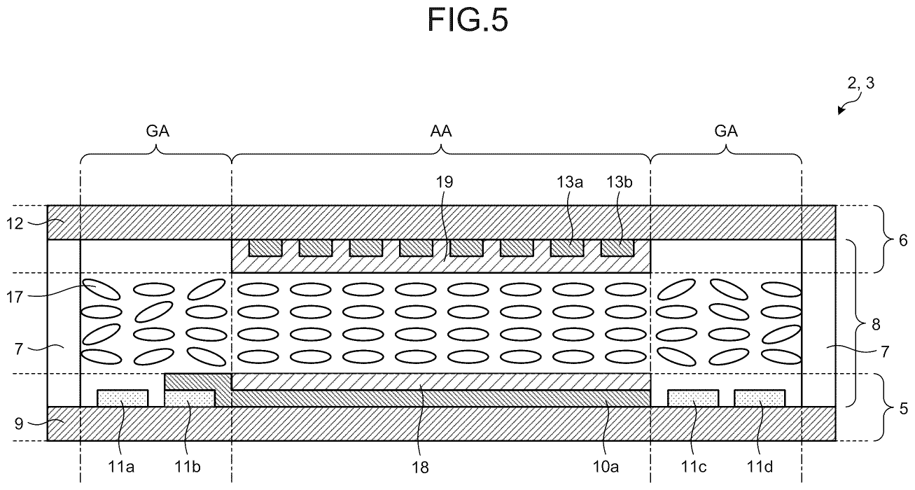

The first liquid crystal cell 2 and the second liquid crystal cell 3 each include a first substrate 5 and a second substrate 6. FIG. 2 is a schematic plan view of the first substrate when viewed in the Dz direction. FIG. 3 is a schematic plan view of the second substrate when viewed in the Dz direction. FIG. 4 is a fluoroscopic diagram of a liquid crystal cell in which the first substrate and the second substrate are stacked in the Dz direction. FIG. 5 is a sectional view along line A-A′ illustrated in FIG. 4.

As illustrated in FIG. 5, the first liquid crystal cell 2 and the second liquid crystal cell 3 each include a liquid crystal layer 8 between the first substrate 5 and the second substrate 6, and the liquid crystal layer 8 has a periphery sealed by a sealing member 7.

The liquid crystal layer 8 modulates light passing through the liquid crystal layer 8 in accordance with the state of electric field. The liquid crystal layer 8 may be, for example, of a horizontal electric field mode such as fringe field switching (FFS), which is a form of in-plane switching (IPS), or may be of a vertical electric field mode. Liquid crystal of various modes such as twisted nematic (TN), vertical alignment (VA), and electrically controlled birefringence (ECB) may be used, and the present disclosure is not limited by the type and configuration of the liquid crystal layer 8.

As illustrated in FIG. 2, a plurality of drive electrodes 10a and 10b, a plurality of metal lines 11a and 11b, and a plurality of metal lines 11c and 11d are provided on the liquid crystal layer 8 side of a base memberl 9 of the first substrate 5 illustrated in FIG. 5. The metal lines 11a and 11b supply drive voltage to the drive electrodes 10 (drive electrodes 10a and 10b), and the metal lines 11c and 11d supply drive voltage to a plurality of drive electrodes 13a and 13b (refer to FIG. 3) provided at the second substrate 6 to be described later. The metal lines 11a, 11b, 11c, and 11d are provided in a wiring layer of the first substrate 5. The metal lines 11a, 11b, 11c, and 11d are provided at intervals in the wiring layer on the first substrate 5. Hereinafter, the drive electrodes 10a and 10b are simply referred to as “drive electrodes 10” in some cases. In addition, the metal lines 11a, 11b, 11c, and 11d are referred to as “first metal lines 11” in some cases. As illustrated in FIG. 2, the drive electrodes 10 on the first substrate 5 extend in the Dx direction.

As illustrated in FIG. 3, the drive electrodes 13a and 13b and a plurality of metal lines 14a and 14b are provided on the liquid crystal layer 8 side of a base member 12 of the second substrate 6 illustrated in FIG. 5. The metal lines 14a and 14b supply drive voltage to the drive electrodes 13 (drive electrodes 13a and 13b). The metal lines 14a and 14b are provided in a wiring layer of the second substrate 6. The metal lines 14a and 14b are provided at intervals in the wiring layer on the second substrate 6. Hereinafter, the drive electrodes 13a and 13b are simply referred to as “drive electrodes 13” in some cases. In addition, the metal lines 14a and 14b are referred to as “second metal lines 14” in some cases. As illustrated in FIG. 3, the drive electrodes 13 on the second substrate 6 extend in the Dy direction.

The drive electrodes 10 and 13 are light-transmitting electrodes formed of a light-transmitting conductive material (light-transmitting conductive oxide) such as indium tin oxide (ITO). The first substrate 5 and the second substrate 6 are light-transmitting substrates of glass, resin, or the like. The first metal lines 11 and the second metal lines 14 are formed of at least one metallic material among aluminum (Al), copper (Cu), silver (Ag), molybdenum (Mo), and alloy thereof. The first metal lines 11 and the second metal lines 14 may be each formed of one or more of these metallic materials as a multilayered body of a plurality of layers. The at least one metallic material among aluminum (Al), copper (Cu), silver (Ag), molybdenum (Mo), and alloy thereof has a resistance lower than that of light-transmitting conductive oxide such as ITO.

The metal line 11a of the first substrate 5 and the metal line 14a of the second substrate 6 are coupled to each other through a conduction part 15a such as a via. The metal line 11d of the first substrate 5 and the metal line 14b of the second substrate 6 are coupled to each other through a conduction part 15b such as a via.

Coupling (Flex-on-Board) terminal parts 16a and 16b coupled to non-illustrated flexible printed circuits (FPC) are provided in a region on the first substrate 5, which does not overlap the second substrate 6 when viewed in the Dz direction. The coupling terminal parts 16a and 16b each include four coupling terminals corresponding to the metal lines 11a, 11b, 11c, and 11d.

The coupling terminal parts 16a and 16b are provided in the wiring layer of the first substrate 5. Drive voltage that is applied to the drive electrodes 10a and 10b on the first substrate 5 and the drive electrodes 13a and 13b on the second substrate 6 is supplied to the first liquid crystal cell 2 and the second liquid crystal cell 3 from the FPC coupled to the coupling terminal part 16a or 16b. Hereinafter, the coupling terminal parts 16a and 16b are simply referred to as “coupling terminal parts 16” in some cases.

As illustrated in FIG. 4, in the first liquid crystal cell 2 and the second liquid crystal cell 3, the first substrate 5 and the second substrate 6 are stacked in the Dz direction (light irradiation direction), and the drive electrodes 10 on the first substrate 5 intersect the drive electrodes 13 on the second substrate 6 when viewed in the Dz direction. In the first liquid crystal cell 2 and the second liquid crystal cell 3 thus configured, the orientation direction of liquid crystal molecules 17 in the liquid crystal layer 8 can be controlled by supplying drive voltage to each of the drive electrodes 10 on the first substrate 5 and the drive electrodes 13 on the second substrate 6. A region in which the orientation direction of the liquid crystal molecules 17 in the liquid crystal layer 8 can be controlled is referred to as a “light control region AA”. The refractive index distribution of the liquid crystal layer 8 in the light control region AA is changed, whereby light transmitted through the light control region AA of each of the first liquid crystal cell 2 and the second liquid crystal cell 3 can be controlled. A region outside the light control region AA where the liquid crystal layer 8 is sealed by the sealing member 7 is referred to as a “peripheral region GA” (refer to FIG. 5).

As illustrated in FIG. 5, the drive electrodes 10 (in FIG. 5, the drive electrode 10a) are covered by an alignment film 18 in the light control region AA of the first substrate 5. In addition, the drive electrodes 13 (in FIG. 5, the drive electrodes 13a and 13b) are covered by an alignment film 19 in the light control region AA of the second substrate 6. The alignment film 18 and the alignment film 19 have different rubbing directions.

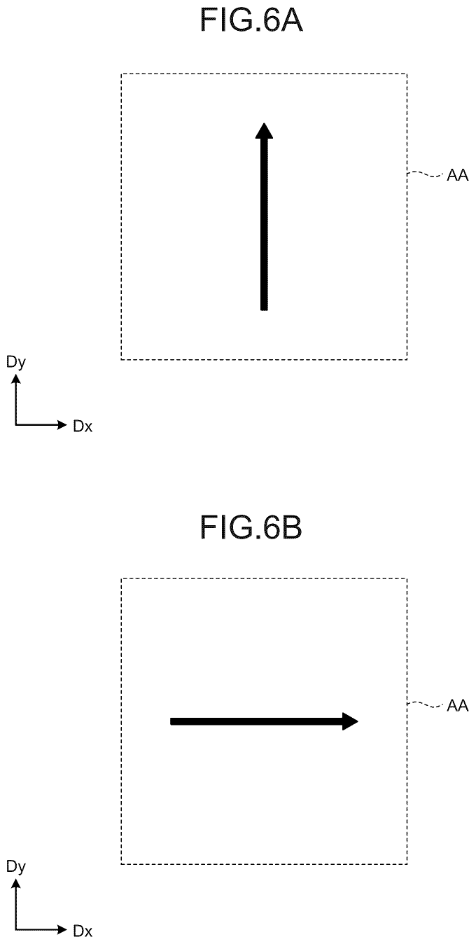

FIG. 6A is a diagram illustrating the rubbing direction of the alignment film of the first substrate. FIG. 6B is a diagram illustrating the rubbing direction of the alignment film of the second substrate.

As illustrated in FIGS. 6A and 6B, the rubbing direction of the alignment film 18 of the first substrate 5 and the rubbing direction of the alignment film 19 of the second substrate 6 are directions intersecting each other in plan view. Specifically, the rubbing direction of the alignment film 18 of the first substrate 5 illustrated in FIG. 6A is orthogonal to the extension direction of the drive electrodes 10a and 10b. The rubbing direction of the alignment film 19 of the second substrate 6 illustrated in FIG. 6B is orthogonal to the extension direction of the drive electrodes 13a and 13b.

The present embodiment describes the configuration in which one first liquid crystal cell 2 and one second liquid crystal cell 3 are stacked, but is not limited to this configuration, and for example, a configuration including a plurality of combinations obtained by stacking the first liquid crystal cell 2 and the second liquid crystal cell 3 is also applicable. For example, a configuration including two combinations each of which is obtained by stacking the first liquid crystal cell 2 and the second liquid crystal cell 3, in other words, a configuration including two liquid crystal cells for p wave polarization and two liquid crystal cells for s wave polarization is applicable.

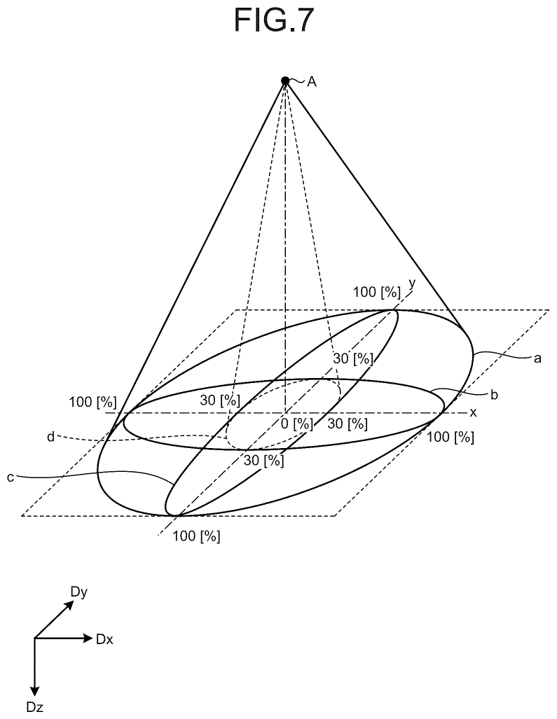

In the present disclosure, the distribution angle of light emitted from the light source 4 is controlled through drive voltage control of the first liquid crystal cell 2 and the second liquid crystal cell 3 in the illumination device 1 having the above-described configuration. The following describes the distribution angle of light from the illumination device 1, which is one of control parameters in the present disclosure, with reference to FIG. 7.

FIG. 7 is a conceptual diagram for conceptually describing the distribution angle of light from the illumination device according to the embodiment. In FIG. 7, the illumination device 1 is assumed to be a point light source A, and the irradiation area of light on an imaginary plane xy orthogonal to the Dz direction is illustrated. Although FIG. 7 illustrates the example in which the illumination device 1 is assumed to be the point light source A, light that is transmitted through the light control region AA of each of the first liquid crystal cell 2 and the second liquid crystal cell 3 is controlled as described above in reality, and thus the illuminance of light decreases around the irradiation area. Furthermore, the outline of the irradiation area is indistinct due to light diffraction phenomenon and the like.

As described above, in each of the first liquid crystal cell 2 and the second liquid crystal cell 3, the orientation direction of the liquid crystal molecules 17 in the liquid crystal layer 8 is controlled by supplying drive voltage to each of the drive electrodes 10 on the first substrate 5 and the drive electrodes 13 on the second substrate 6. Thus, the distribution angle of light that is emitted from the illumination device 1 can be controlled.

Specifically, for example, the orientation direction of the liquid crystal molecules 17 in the liquid crystal layer 8 of the first liquid crystal cell 2 changes in accordance with the drive voltage applied to the drive electrodes 10 and 13 of the first liquid crystal cell 2, whereby the distribution angle in the Dx direction changes. In the present disclosure, the minimum distribution angle in the Dx direction is 0% and the maximum distribution angle in the Dx direction is 100%.

For example, the orientation direction of the liquid crystal molecules 17 in the liquid crystal layer 8 of the second liquid crystal cell 3 changes and the distribution angle in the Dy direction changes in accordance with drive voltage applied to the drive electrodes 10 and 13 of the second liquid crystal cell 3. In the present disclosure, the minimum distribution angle in the Dy direction is 0% and the maximum distribution angle in the Dy direction is 100%.

In FIG. 7, “a” exemplarily illustrates the irradiation area in a case where the distribution angle in the Dx direction and the distribution angle in the Dy direction are both 100%. In FIG. 7, “b” exemplarily illustrates the irradiation area in a case where the distribution angle in the Dx direction is 100% and the distribution angle in the Dy direction is 30%. In FIG. 7, “c” exemplarily illustrates the irradiation area in a case where the distribution angle in the Dx direction is 30% and the distribution angle in the Dy direction is 100%. In FIG. 7, “d” exemplarily illustrates the irradiation area in a case where the distribution angle in the Dx direction and the distribution angle in the Dy direction are both 30%.

In this manner, the distribution angle of light in the Dx and Dy directions can be controlled by performing drive voltage control of each of the first liquid crystal cell 2 and the second liquid crystal cell 3 in the illumination device 1 having the above-described configuration. Thus, the irradiation area of light from the illumination device 1 can be changed.

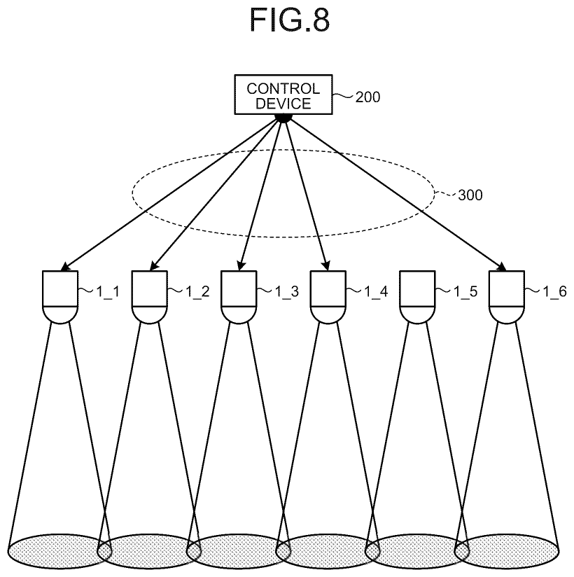

FIG. 8 is a schematic diagram illustrating an example of the configuration of an illumination system according to the embodiment. The illumination system includes a plurality of illumination devices 1 each having a light adjustment function, and a control device 200. The control device 200 is, for example, a portable communication terminal device such as a smartphone or a tablet. FIG. 8 illustrates an example in which a plurality of illumination devices 1_1, 1_2, . . . , 1_6 are disposed in the same space.

Data and various command signals are transmitted and received between each of the illumination devices 1 (1_1, 1_2, . . . , 1_6) and the control device 200 through a communication means 300. In the present disclosure, the communication means 300 is a wireless communication means such as Bluetooth (registered trademark) or WiFi (registered trademark). Wireless communication may be performed between the illumination device 1 and the control device 200 through a predetermined network such as a mobile communication network. Alternatively, the illumination device 1 and the control device 200 may be coupled to each other in a wired manner to perform wired communication therebetween. The present disclosure is not limited by the number of illumination devices 1 included in the illumination system.

In the present disclosure, exemplary control parameters of the control device 200 include the light emission intensity, white balance, light emission color, and distribution angle of each illumination device 1. Hereinafter, control of adjusting control parameters such as the light emission intensity, white balance, light emission color, and distribution angle of each illumination device 1 is also collectively referred to as “light adjustment control”.

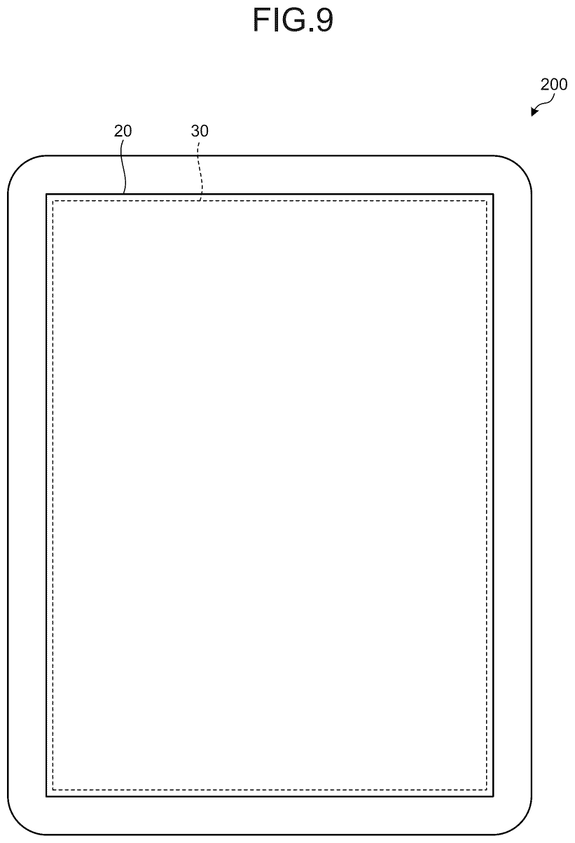

FIG. 9 is an external view illustrating an example of the control device according to the embodiment. The control device 200 is a display device equipped with a touch detection function, in which a display panel 20 and a touch sensor 30 are integrated. Specifically, the display panel 20 is what is called an in-cell type or hybrid type device in which the touch sensor 30 is integrated. The configuration in which the touch sensor 30 is integrated in the display panel 20 includes, for example, a configuration in which some components such as substrates and electrodes are used as both components of the display panel 20 and components of the touch sensor 30. The display panel 20 may be what is called an on-cell type device in which the touch sensor 30 is mounted on a display device.

The display panel 20 is, for example, a liquid crystal display panel including a liquid crystal display element. The display panel 20 is not limited thereto but may be, for example, an organic EL display panel (OLED: organic light emitting diode) or an inorganic EL display panel (micro LED or mini LED).

The touch sensor 30 is, for example, a capacitive touch sensor. The touch sensor 30 is not limited thereto but may be, for example, a touch sensor of a resistance film type, a touch sensor of an ultrasonic wave type, or a touch sensor of an optical type.

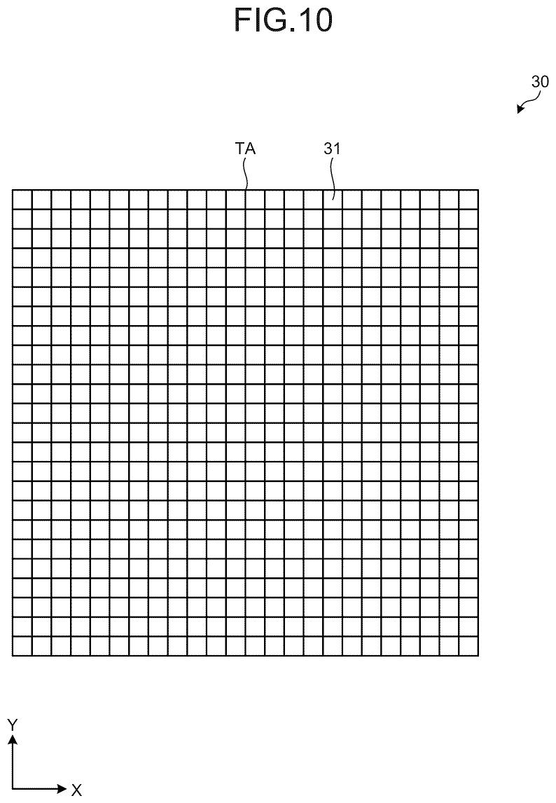

FIG. 10 is a conceptual diagram illustrating an example of a detection region of the touch sensor. A plurality of detection elements 31 are provided in a detection region FA of the touch sensor 30. In the detection region FA of the touch sensor 30, the detection elements 31 are arranged in an X direction (first direction) and a Y direction (second direction) orthogonal to the X direction and provided in a matrix of rows and columns. In other words, the touch sensor 30 includes the detection region FA overlapping the detection elements 31 arranged in the X direction (first direction) and the Y direction (second direction).

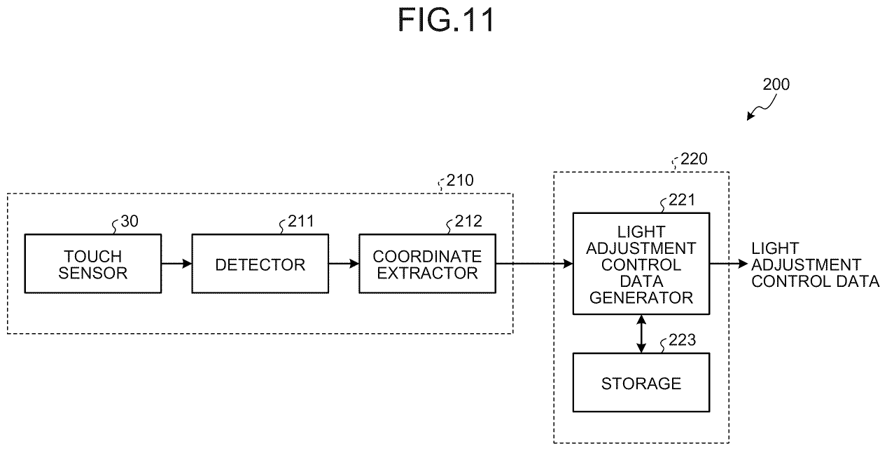

FIG. 11 is a diagram illustrating an example of a control block configuration of the control device according to the embodiment.

As illustrated in FIG. 11, the control device 200 according to the embodiment includes a detection device 210 and a processing device 220. The detection device 210 includes the touch sensor 30, a detector 211, and a coordinate extractor 212. The processing device 220 includes a light adjustment control data generator 221 and a storage 223. The detector 211 and the coordinate extractor 212 of the detection device 210 are each constituted by, for example, a detection IC. The processing device 220 includes, for example, a central processing unit (CPU), a random access memory (RAN), an electrically erasable programmable read only memory (EEPROM), and a read only memory (ROM) of the smartphone, the tablet, or the like as the control device 200.

The detector 211 is a circuit configured to detect existence of a touch on or above the touch sensor 30 based on a detection signal output from each detection element 31 of the touch sensor 30.

The coordinate extractor 212 is a logic circuit configured to calculate the coordinates of a touch detection position when a touch is detected by the detector 211.

The light adjustment control data generator 221 generates light adjustment control data based on the touch detection position extracted by the coordinate extractor 212. The light adjustment control data generator 221 is a component implemented by, for example, the CPU of the smartphone, the tablet, and the like as the control device 200.

The storage 223 is composed of, for example, the RAM, EEPROM, or ROM of the smartphone, the tablet, or the like as the control device 200. In the present disclosure, the storage 223 stores, for example, light adjustment control data corresponding to the coordinate of the touch detection position extracted by the coordinate extractor 212.

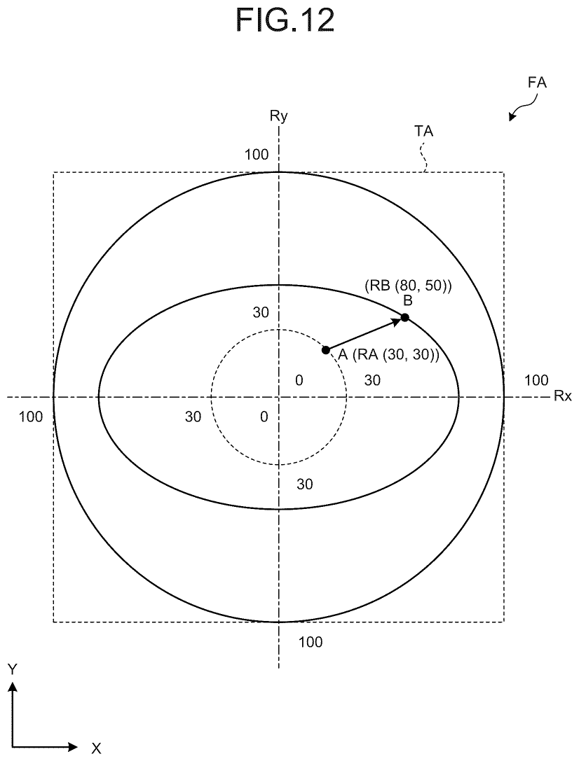

FIG. 12 is a conceptual diagram illustrating an example of a light adjustment control data adjustment method in the embodiment. A method of adjusting the distribution angle as one of the control parameters of each illumination device 1 is illustrated with reference to FIG. 12.

As illustrated in FIG. 12, a data adjustment region TA is provided in the detection region FA of the touch sensor 30. The horizontal axis of the data adjustment region TA represents a coordinate axis in the X direction (first direction) and corresponds to the Dx direction of the illumination device 1. The vertical axis of the data adjustment region TA represents a coordinate axis in the Y direction (second direction) and corresponds to the Dy direction of the illumination device 1. The data adjustment region TA only needs to be provided in the detection region FA of the touch sensor 30 and may be the entire detection region FA.

In the present embodiment, distribution angle data in the X direction and distribution angle data in the Y direction are discrete values obtained by normalizing information on the distribution angle that is controlled in the illumination device 1. Specifically, in the present embodiment, the light adjustment control data generator 221 generates distribution angle data R(Rx, Ry) by using information on the distribution angle to be controlled in the illumination device 1 as a parameter of control by the control device 200.

The distribution angle data Rx in the X direction and the distribution angle data Ry in the Y direction are defined to be values corresponding to the coordinates of the touch detection position detected in the data adjustment region TA. In the example illustrated in FIG. 12, the distribution angle data Rx in the X direction and the distribution angle data Ry in the Y direction each can take a value of “0” to “100”. The circle illustrated with a dashed line in FIG. 12 indicates the locus of the coordinates of a position where the distribution angle data Rx in the X direction is “30” and the distribution angle data Ry in the Y direction is “30”, the circle illustrated with a solid line indicates the locus of the coordinates of a position where the distribution angle data Rx in the X direction is “100” and the distribution angle data Ry in the Y direction is “100”, and the ellipse illustrated with a solid line indicates the locus of the coordinate of a position where the distribution angle data Rx in the X direction is “80” and the distribution angle data Ry in the Y direction is “50”.

In the example illustrated in FIG. 12, the coordinates of the touch detection position obtained by the coordinate extractor 212 are moved from a position A to a position B in the data adjustment region TA. In this case, the light adjustment control data generator 221 generates the distribution angle data R(Rx, Ry) in accordance with the coordinates (x, y) of the touch detection position, which is output from the coordinate extractor 212 on a time-series basis while the coordinates of the touch detection position move from the position A to the position B in the data adjustment region TA. Specifically, the relation between change ΔR(ΔRx, ΔRy) of the distribution angle data R(Rx, Ry) by one step and change (Δx, Δy) of the coordinates (x, y) of the touch detection position by one step is expressed by Expressions (1) and (2) below. In the expressions, k is a coefficient determined by the number of detection elements 31 in the data adjustment region TA.

ΔRx=k×Δx (1)

ΔRy=k×Δy (2)

Specifically, in a case of k=4, for example, the distribution angle data changes by one step when the coordinates of the touch detection position moves by four. In other words, the change amount of the distribution angle data R(Rx, Ry) is proportional to the movement amount of the coordinate (x, y) of the touch detection position.

In the present disclosure, the light adjustment control of the control parameters of each illumination device 1 is executed by the control device 200 and the illumination device 1. The control device 200 sequentially transmits the distribution angle data R(Rx, Ry) generated by the light adjustment control data generator 221 to the illumination device 1 as a light adjustment control target.

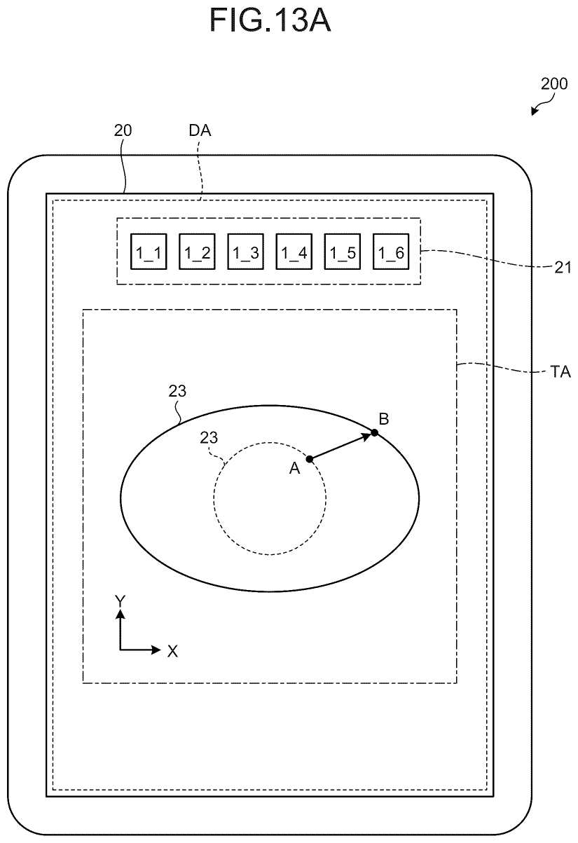

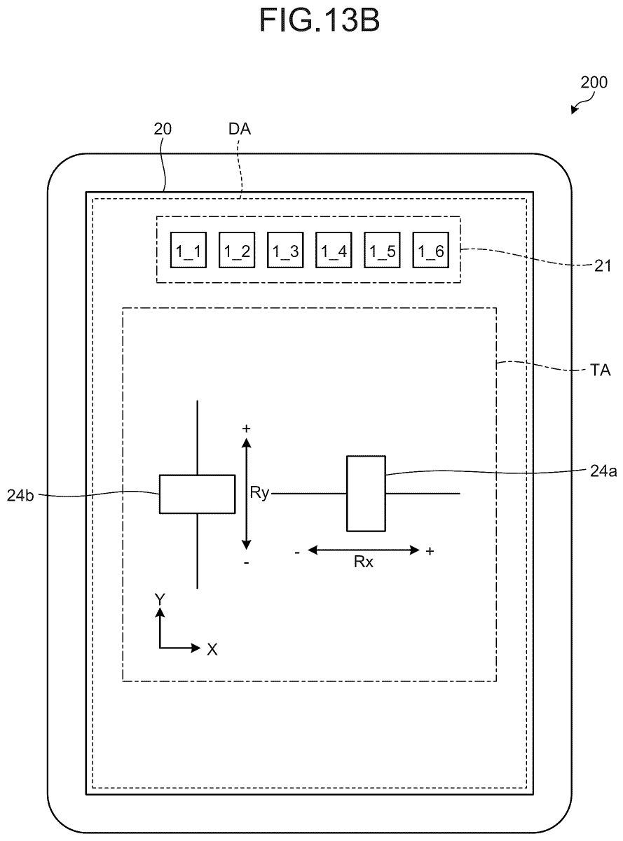

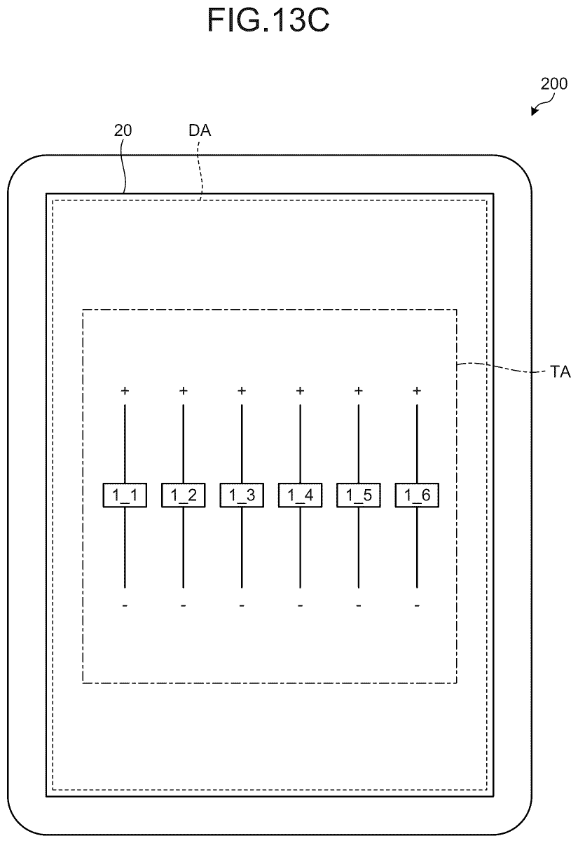

FIG. 13A is a conceptual diagram illustrating a first display example of the control device according to the embodiment for adjusting the distribution angle. FIG. 13B is a conceptual diagram illustrating a second display example of the control device according to the embodiment for adjusting the distribution angle.

A display region DA that overlaps the detection region FA of the touch sensor 30 illustrated in FIG. 9 in plan view is provided on the display panel 20. As illustrated in FIGS. 13A and 13B, for example, control target selection icons 21 for selecting an illumination device 1 as a light adjustment control target of the control device 200 from among the illumination devices 1_1, 1_2, . . . , 1_6 are provided in a region outside the data adjustment region TA in the display region DA. In the examples illustrated in FIGS. 13A and 13B, the control target selection icons 21 are provided in a region on the upper side of the data adjustment region TA. It is possible, by tapping one of the control target selection icons 21, to select an illumination device 1 corresponding to the tapped icon as a light adjustment control target from among the illumination devices 1_1, 1_2, . . . , 1_6.

In the aspect illustrated in FIG. 13A, the locus of the coordinates of the position corresponding to the distribution angle data R(Rx, Ry) on the data adjustment region TA is displayed as a schematic shape image 23 of the irradiation area. In this first display example, the distribution angle in the X direction and the distribution angle in the Y direction of the illumination device 1 subject to the light adjustment control are simultaneously adjusted by, for example, tapping the position A on the schematic shape image 23 of the irradiation area and swiping from the position A to the position B.

In the aspect illustrated in FIG. 13B, a slide bar 24a for adjusting the distribution angle in the X direction and a slide bar 24b for adjusting the distribution angle in the Y direction are displayed on the data adjustment region TA. In this second display example, the distribution angle of the illumination device 1 subject to the light adjustment control in the X direction is adjusted by tapping and swiping the slide bar 24a in the X direction, and the distribution angle of the illumination device 1 subject to the light adjustment control in the Y direction is adjusted by tapping and swiping the slide bar 24b in the Y direction.

FIG. 13C is a conceptual diagram illustrating a display example of the control device according to the embodiment for adjusting the light emission intensity. A method of adjusting the light emission intensity as one of the control parameters of each illumination device 1 will be described below with reference to FIG. 13C.

In the example illustrated in FIG. 13C, slide bars for adjusting the light emission intensity are displayed on the data adjustment region TA for the illumination devices 1_1, 1_2, . . . , 1_6, respectively. In this display example, the light emission intensity of the illumination device 1 subject to the light adjustment control is adjusted by tapping and swiping the slide bar corresponding to the illumination device 1 subject to the light adjustment control.

The method of adjusting control parameters such as the distribution angle and the light emission intensity is not limited to the above-described example but may be, for example, a configuration in which the control device 200 is provided with physical sliders may be used.

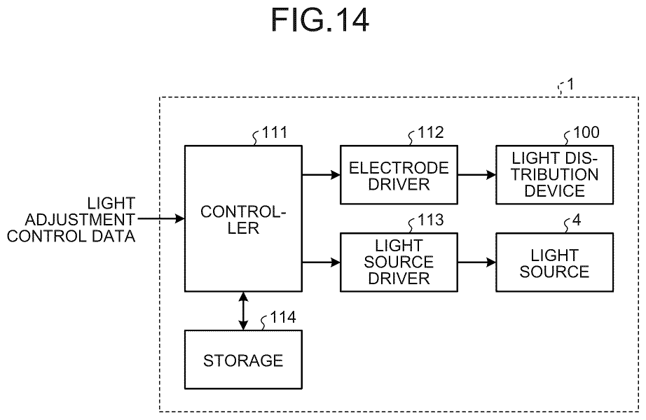

FIG. 14 is a diagram illustrating an example of a control block configuration of each illumination device according to the embodiment. As illustrated in FIG. 14, each illumination device 1 according to a first embodiment includes a controller 111, an electrode driver 112, a light source driver 113, and a storage 114 in addition to the light source 4 and the light distribution device 100 described above.

The controller 111 executes the light adjustment control in accordance with light adjustment control data received from the control device 200. Specifically, for example, the controller 111 controls the electrode driver 112 so that drive voltage in accordance with distribution angle data R(Rx, Ry) transmitted from the control device 200 is supplied to the drive electrodes 10 and 13 of the first liquid crystal cell 2 and the second liquid crystal cell 3 of the light distribution device 100. For example, the controller 111 controls the light source driver 113 so that drive current in accordance with light emission intensity data transmitted from the control device 200 is supplied to the light source 4.

As illustrated in FIG. 8, for example, in a case where the illumination devices 1 (1_1, 1_2, . . . , 1_6) are disposed in the same space and one of the illumination devices 1 is subject to the light adjustment control, effects of the light adjustment control of the illumination device 1 subject to the light adjustment control are difficult to recognize in some cases due to interference with light emitted from any illumination device 1 different from the illumination device 1 subject to the light adjustment control (hereinafter also expressed as “not subject to the light adjustment control”). The following describes a method of performing the light adjustment control appropriately on the illumination device 1 subject to the light adjustment control in the illumination system including the illumination devices 1.

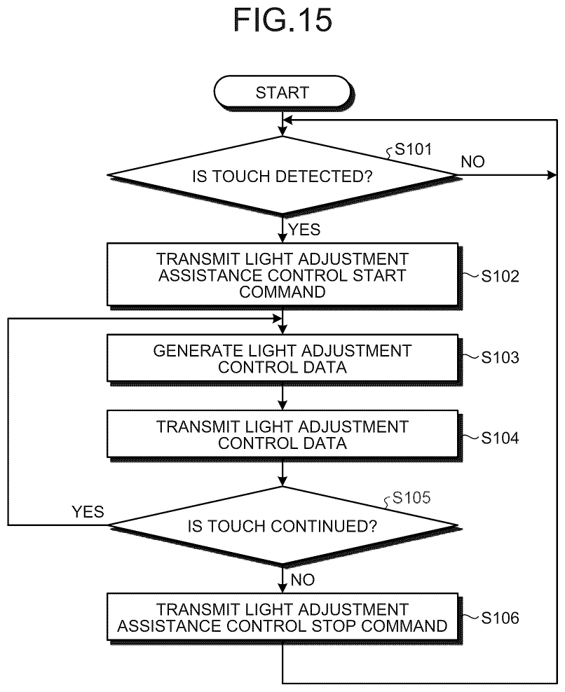

FIG. 15 is a flowchart illustrating an example of light adjustment control processing by the control device according to the embodiment. The following description will be made of an example in which the illumination device 1_3 illustrated in FIG. 8 is subject to the light adjustment control and the illumination devices 1_1, 1_2, 1_4, 1_5, and 1_6 are not subject to the light adjustment control.

The detector 211 detects existence of a touch in the data adjustment region TA of the touch sensor 30 (step S101). In a case where no touch is detected in the data adjustment region TA (No at step S101), the control device 200 executes the processing at step S101 again.

In a case where a touch is detected in the data adjustment region TA (Yes at step S101), the control device 200 transmits, through the communication means 300, a light adjustment assistance control start command to the illumination devices 1_1, 1_2, 1_4, 1_5, and 1_6 not subject to the light adjustment control (step S102).

The light adjustment control data generator 221 of the control device 200 generates light adjustment control data corresponding to the coordinates of the touch detection position extracted by the coordinate extractor 212 (step S103). Specifically, for example, the light adjustment control data generator 221 reads, from the storage 223, distribution angle data corresponding to the coordinates of the touch detection position extracted by the coordinate extractor 212.

The control device 200 transmits, through the communication means 300, the light adjustment control data generated by the light adjustment control data generator 221 to the illumination device 1_3 subject to the light adjustment control (step S104).

The detector 211 detects whether the touch is continued in the data adjustment region TA of the touch sensor 30 (step S105).

In a case where the touch is continued in the data adjustment region TA of the touch sensor 30 (Yes at step S105), the process returns to the processing at step S103 and executes the processing starting from step S103 again.

In a case where the touch is not continued in the data adjustment region TA (No at step S105), the control device 200 transmits, through the communication means 300, a light adjustment assistance control stop command to the illumination devices 1_1, 1_2, 1_4, 1_5, and 1_6 not subject to the light adjustment control (step S106). Then, the process returns to the processing at step S101 and executes the same processing again.

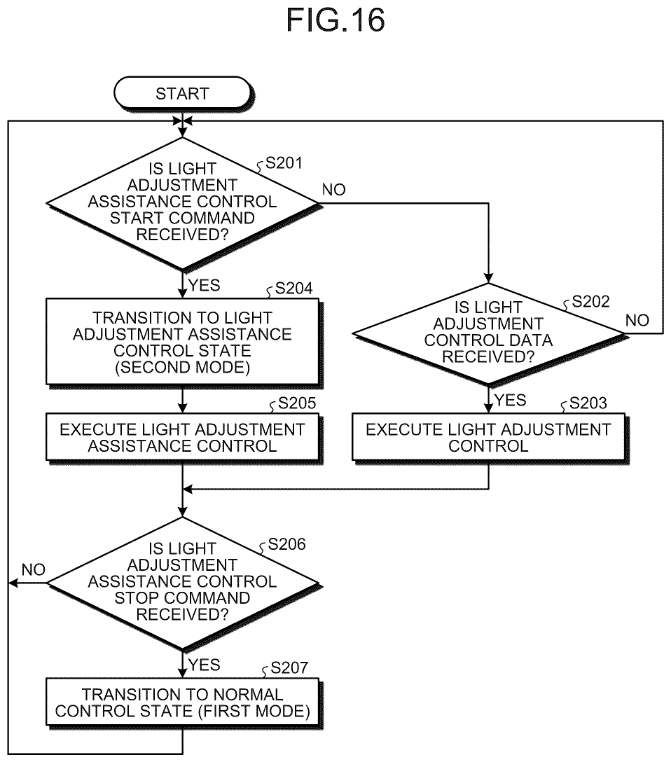

FIG. 16 is a flowchart illustrating an example of the light adjustment control processing by each illumination device according to the embodiment.

The illumination device 1 determines whether the light adjustment assistance control start command transmitted from the control device 200 is received (step S201). In a case where the light adjustment assistance control start command is not received (No at step S201), the illumination device 1 subsequently determines whether the light adjustment control data transmitted from the control device 200 is received (step S202). In a case where the light adjustment control data is not received (No at step S202), the process returns to step S201.

In a case where the light adjustment control data is received (Yes at step S202), the controller 111 executes the light adjustment control in accordance with the light adjustment control data (step S203).

In a case where the light adjustment assistance control start command is received at step S201 (Yes at step S201), the controller 111 transitions from a normal control state (first mode) in a normal light emission period to a light adjustment assistance control state (second mode) in a light adjustment assistance control period (step S204) and executes light adjustment assistance control in a predetermined light emission pattern (light adjustment state) (step S205).

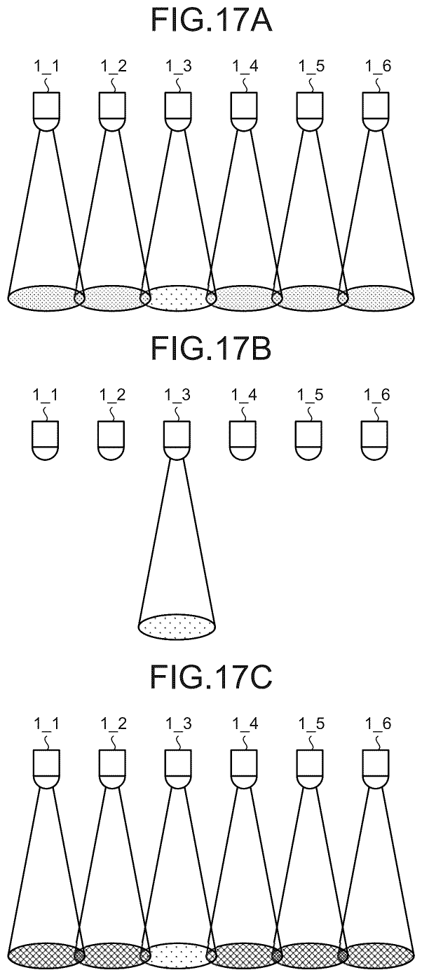

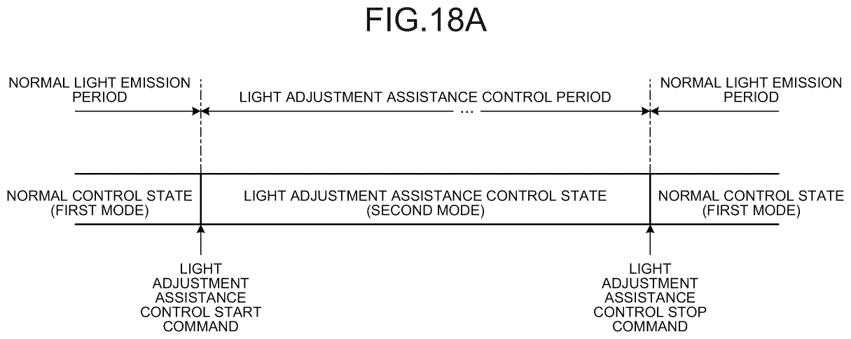

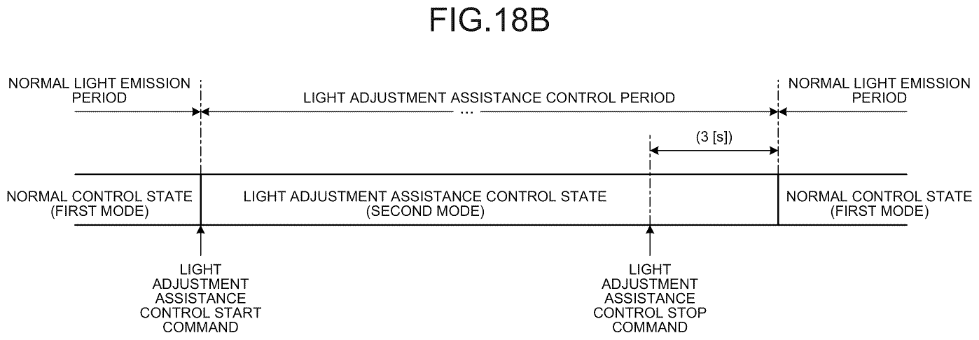

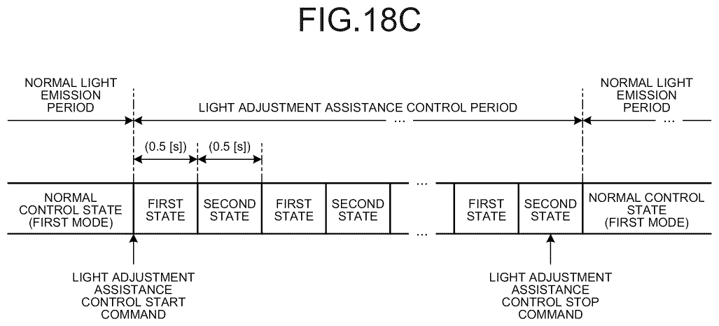

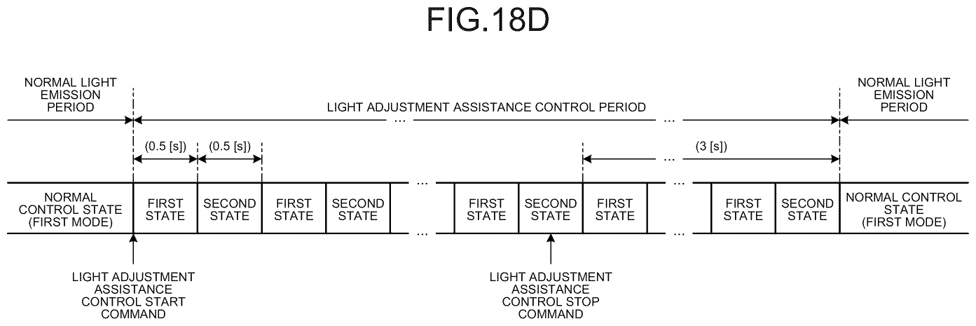

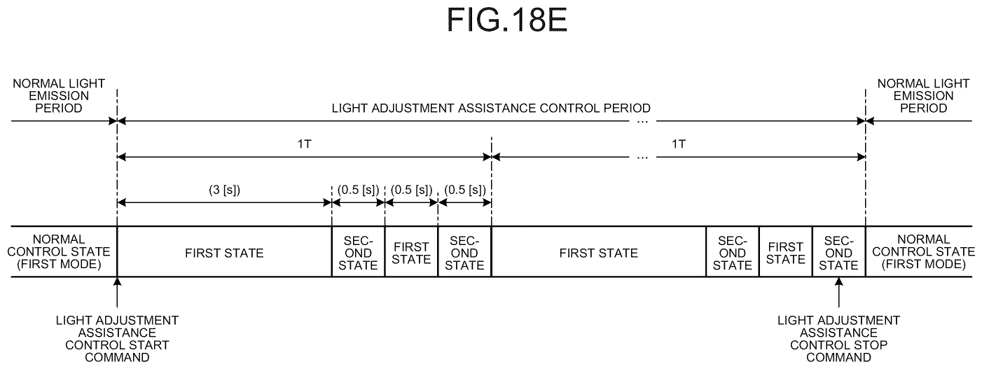

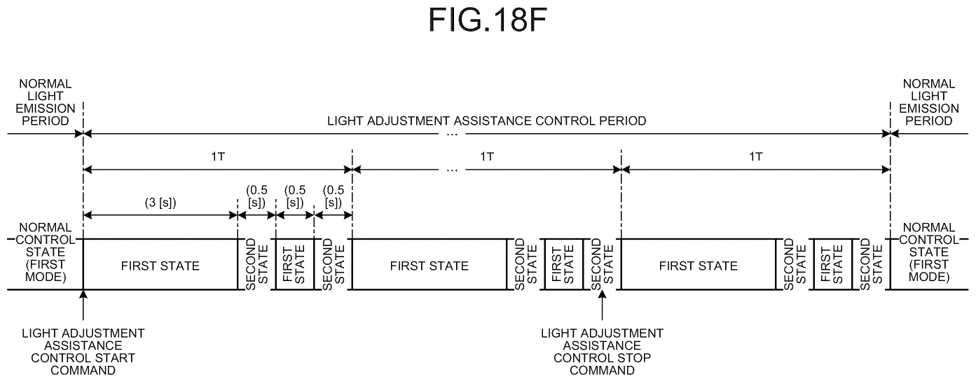

The light adjustment assistance control according to the embodiment will be described below with reference to FIGS. 17A, 17B, 17C, 18A, 18B, 18C, 18D, 18E, and 18F.

FIGS. 17A, 17B, and 17C are conceptual diagrams for describing operation of each illumination device in light adjustment control of the illumination system according to the embodiment. FIGS. 18A, 18B, 18C, 18D, 18E, and 18F are diagrams illustrating an example of the light adjustment assistance control state of the illumination system according to the embodiment.

As illustrated in FIGS. 18A, 18B, 18C, 18D, 18E, and 18F, when the light adjustment assistance control start command transmitted from the control device 200 is received (Yes at step S201), each of the illumination devices 1_1, 1_2, 1_4, 1_5, and 1_6 not subject to the light adjustment control makes a transition from the normal control state (first mode) illustrated in FIG. 17A to the light adjustment assistance control state (second mode). The light emission pattern (light adjustment state) of each of the illumination devices 1_1, 1_2, 1_4, 1_5, and 1_6 not subject to the light adjustment control is different between the normal control state (first mode) and the light adjustment assistance control state (second mode). In the present embodiment, the light emission pattern (light adjustment state) in the light adjustment assistance control state (second mode) is stored in the storage 114 in advance.

The illumination devices 1_1, 1_2, 1_4, 1_5, and 1_6 not subject to the light adjustment control are lit (turned on) in the normal control state (first mode), and for example, the illumination devices 1_1, 1_2, 1_4, 1_5, and 1_6 not subject to the light adjustment control are not lit (turned off) as illustrated in FIG. 17B in the light adjustment assistance control state (second mode). Accordingly, the light adjustment control of the illumination device 1_3 subject to the light adjustment control can be performed without interference with light emitted from the illumination devices 1_1, 1_2, 1_4, 1_5, and 1_6 not subject to the light adjustment control, and thus effects of the light adjustment control of the illumination device 1_3 subject to the light adjustment control are easy to recognize.

The light emission pattern (light adjustment state) in the light adjustment assistance control state (second mode) is not limited thereto, but for example, the illumination devices 1_1, 1_2, 1_4, 1_5, and 1_6 not subject to the light adjustment control may be dimmed (reduced in light quantity) as illustrated in FIG. 17C. Specifically, the light emission intensity of the illumination devices 1_1, 1_2, 1_4, 1_5, and 1_6 not subject to the light adjustment control is set to a predetermined value to lower illuminance. Thus, influence of interference with light emitted from the illumination devices 1_1, 1_2, 1_4, 1_5, and 1_6 not subject to the light adjustment control can be reduced.

The light emission pattern (light adjustment state) of the illumination devices 1_1, 1_2, 1_4, 1_5, and 1_6 not subject to the light adjustment control in the light adjustment assistance control state (second mode) is not limited to turning-off and/or dimming, but for example, the light emission color of the illumination devices 1_1, 1_2, 1_4, 1_5, and 1_6 not subject to the light adjustment control may be changed to a light emission color (second light emission color) different from a light emission color (first light emission color) in the normal control state (first mode).

Alternatively, for example, a first state (first light adjustment state) and a second state (second light adjustment state) different from the first state (first light adjustment state) are switched alternately at predetermined intervals (for example, 0.5 s) as illustrated in FIG. 18C in the light adjustment assistance control state (second mode). Specifically, for example, the illumination devices 1_1, 1_2, 1_4, 1_5, and 1_6 not subject to the light adjustment control are lit in the second state (second light adjustment state) in the same manner as the light emission pattern (light adjustment state) in the normal control state (first mode), and the illumination devices 1_1, 1_2, 1_4, 1_5, and 1_6 not subject to the light adjustment control are not lit in the first state (first light adjustment state). Thus, it is possible to perform the light adjustment control of the illumination device 1_3 subject to the light adjustment control while alternately checking the first state (first light adjustment state) in which the illumination device 1_3 subject to the light adjustment control is on (lit) alone and the second state (second light adjustment state) in which the illumination devices 1_1, 1_2, 1_4, 1_5, and 1_6 not subject to the light adjustment control are on (lit) as in the normal control state (first mode).

Alternatively, for example, the illumination devices 1_1, 1_2, 1_4, 1_5, and 1_6 not subject to the light adjustment control are lit in the second state (second light adjustment state) in the same manner as the light emission pattern (light adjustment state) in the normal control state (first mode), and the illumination devices 1_1, 1_2, 1_4, 1_5, and 1_6 not subject to the light adjustment control are dimmed in the first state (first light adjustment state) relative to the second state (second light adjustment state). Specifically, the light emission intensity of the illumination devices 1_1, 1_2, 1_4, 1_5, and 1_6 not subject to the light adjustment control is set to a predetermined value to lower illuminance. Thus, it is possible to perform the light adjustment control of the illumination device 1_3 subject to the light adjustment control while alternately checking the first state (first light adjustment state) in which the illumination devices 1_1, 1_2, 1_4, 1_5, and 1_6 not subject to the light adjustment control are dimmed relative to the normal control state (first mode) and the second state (second light adjustment state) in which the illumination devices 1_1, 1_2, 1_4, 1_5, and 1_6 not subject to the light adjustment control are on (lit) as in the normal control state (first mode).

Alternatively, for example, the first state (first light adjustment state) and the second state (second light adjustment state) are switched alternately in a specific pattern as illustrated in FIG. 18E. Specifically, for example, the cycle (1T) consisting of 3 s of the first state (first light adjustment state), 0.5 s of the second state (second light adjustment state), 0.5 s of the first state (first light adjustment state), and 0.5 s of the second state (second light adjustment state) is repeated. Thus, the light adjustment control state of the illumination device 1_3 subject to the light adjustment control is easier to identify.

The light emission color (first light emission color) of the illumination devices 1_1, 1_2, 1_4, 1_5, and 1_6 not subject to the light adjustment control in the second state (second light adjustment state) may be the same light emission color as in the normal control state (first mode), and the light emission color of the illumination devices 1_1, 1_2, 1_4, 1_5, and 1_6 not subject to the light adjustment control in the first state (first light adjustment state) may be changed to a light emission color (second light emission color) different from the light emission color (first light emission color) of the illumination devices 1_1, 1_2, 1_4, 1_5, and 1_6 not subject to the light adjustment control in the second state (second light adjustment state).

In FIG. 16, the illumination device 1 determines whether the light adjustment assistance control stop command transmitted from the control device 200 is received (step S206). In a case where the light adjustment assistance control stop command is not received (No at step S206), the process returns to step S201.

In a case where the light adjustment assistance control stop command is received (Yes at step S206), the controller 111 transitions from the light adjustment assistance control state (second mode) in the light adjustment assistance control period to the normal control state (first mode) in the normal light emission period (step S207), and the process returns to step S201.

In the example illustrated in FIG. 18A, in a case where the light adjustment assistance control stop command transmitted from the control device 200 is received (Yes at step S206), each of the illumination devices 1_1, 1_2, 1_4, 1_5, and 1_6 not subject to the light adjustment control makes a transition from the light adjustment assistance control state (second mode) to the normal control state (first mode).

Alternatively, as illustrated in FIG. 18B, the light adjustment state of each of the illumination devices 1_1, 1_2, 1_4, 1_5, and 1_6 not subject to the light adjustment control may transition from the light adjustment assistance control state (second mode) to the normal control state (first mode), for example, after the elapse of a predetermined time (for example, 3 s) since receiving the light adjustment assistance control stop command transmitted from the control device 200 (Yes at step S206).

Alternatively, as illustrated in FIG. 18D, the transition from the light adjustment assistance control state (second mode) to the normal control state (first mode) may be performed, for example, after the first state (first light adjustment state) and the second state (second light adjustment state) are alternately switched a plurality of times for a predetermined time (for example, 3 s) after receiving the light adjustment assistance control stop command transmitted from the control device 200 (Yes at step S206).

Alternatively, as illustrated in FIG. 18F, the transition from the light adjustment assistance control state (second mode) to the normal control state (first mode) may be performed, for example, after performing a specific pattern in the cycle (1T) consisting of a first period (3 s), a second period (0.5 s), the first period (0.5 s), and the second period (0.5 s) after receiving the light adjustment assistance control stop command transmitted from the control device 200 (Yes at step S206).

In this manner, a period in which the illumination devices 1_1, 1_2, 1_4, 1_5, and 1_6 not subject to the light adjustment control are maintained in the light adjustment assistance control state (second mode) is provided after the light adjustment assistance control stop command transmitted from the control device 200 is received (Yes at step S206). With this operation, the light adjustment control state of the illumination device 1_3 subject to the light adjustment control can be easily checked.

As described above, in the illumination system including the illumination devices each having a light adjustment function, when the light adjustment control of the illumination device 1 (1_3) subject to the light adjustment control is executed, the illumination devices 1 (1_1, 1_2, 1_4, 1_5, and 1_6) not subject to the light adjustment control can be set to the light adjustment assistance control state (second mode) in which the light adjustment control state of the illumination device 1_3 subject to the light adjustment control is easy to identify.

Specifically, the illumination devices 1_1, 1_2, 1_4, 1_5, and 1_6 not subject to the light adjustment control are on (lit) in the normal control state (first mode), and the illumination devices 1 (1_1, 1_2, 1_4, 1_5, and 1_6) not subject to the light adjustment control are off (not lit) in the light adjustment assistance control state (second mode). Accordingly, the light adjustment control of the illumination device 1 (1_3) subject to the light adjustment control can be performed without interference with light emitted from the illumination devices 1 (1_1, 1_2, 1_4, 1_5, and 1_6) not subject to the light adjustment control, and thus effects of the light adjustment control of the illumination device 1 (1_3) subject to the light adjustment control are easy to recognize.

Alternatively, in the light adjustment assistance control state (second mode), the illumination devices 1 (1_1, 1_2, 1_4, 1_5, and 1_6) not subject to the light adjustment control are dimmed. Specifically, the light emission intensity of the illumination devices 1 (1_1, 1_2, 1_4, 1_5, and 1_6) not subject to the light adjustment control is set to a predetermined value to lower illuminance. Thus, influence of interference with light emitted from the illumination devices 1 (1_1, 1_2, 1_4, 1_5, and 1_6) not subject to the light adjustment control can be reduced.

Alternatively, in the light adjustment assistance control state (second mode), the first state (first light adjustment state) and the second state (second light adjustment state) different from the first state (first light adjustment state) are switched alternately at predetermined intervals. Specifically, for example, the illumination devices 1 (1_1, 1_2, 1_4, 1_5, and 1_6) not subject to the light adjustment control are on (lit) in the second state (second light adjustment state) in the same manner as the light emission pattern (light adjustment state) in the normal control state (first mode), and the illumination devices 1 (1_1, 1_2, 1_4, 1_5, and 1_6) not subject to the light adjustment control are off (not lit) in the first state (first light adjustment state). In other words, the illumination devices 1 (1_1, 1_2, 1_4, 1_5, and 1_6) not subject to the light adjustment control are turned off at the predetermined intervals. Thus, it is possible to perform the light adjustment control of the illumination device 1 (1_3) subject to the light adjustment control while alternately checking the first state (first light adjustment state) in which the illumination device 1 (1_3) subject to the light adjustment control is on (lit) alone and the second state (second light adjustment state) in which the illumination devices 1 (1_1, 1_2, 1_4, 1_5, and 1_6) not subject to the light adjustment control are on (lit) as in the normal control state (first mode).

Alternatively, for example, the illumination devices 1 (1_1, 1_2, 1_4, 1_5, and 1_6) not subject to the light adjustment control are on (lit) in the second state (second light adjustment state) as in the same manner as the light emission pattern (light adjustment state) in the normal control state (first mode), and the illumination devices 1 (1_1, 1_2, 1_4, 1_5, and 1_6) not subject to the light adjustment control are dimmed relative to the second state (second light adjustment state) in the first state (first light adjustment state). In other words, the illumination devices 1 (1_1, 1_2, 1_4, 1_5, and 1_6) not subject to the light adjustment control are dimmed at predetermined intervals. Thus, it is possible to perform the light adjustment control of the illumination device 1 (1_3) subject to the light adjustment control while alternately checking the first state (first light adjustment state) in which the illumination devices 1 (1_1, 1_2, 1_4, 1_5, and 1_6) not subject to the light adjustment control are dimmed relative to the normal control state (first mode) and the second state (second light adjustment state) in which the illumination devices 1 (1_1, 1_2, 1_4, 1_5, and 1_6) not subject to the light adjustment control are on (lit) as in the normal control state (first mode).

Alternatively, in the light adjustment assistance control state (second mode), the first state (first light adjustment state) and the second state (second light adjustment state) are switched alternately in a specific pattern. Specifically, for example, the cycle (1T) consisting of 3 s of the first state (first light adjustment state), 0.5 s of the second state (second light adjustment state), 0.5 s of the first state (first light adjustment state), and 0.5 s of the second state (second light adjustment state) is repeated. Thus, the light adjustment control state of the illumination device 1 (1_3) subject to the light adjustment control is easier to identify.

Alternatively, a period in which the illumination devices 1 (1_1, 1_2, 1_4, 1_5, and 1_6) not subject to the light adjustment control are maintained in the light adjustment assistance control state (second mode) is provided after the light adjustment control of the illumination device 1 (1_3) subject to the light adjustment control is executed, and thus, the light adjustment control state of the illumination device 1 (1_3) subject to the light adjustment control can be easily checked.

In the above-described example of the embodiment, one illumination device 1 (1_3) among the illumination devices 1 (1_1, 1_2, 1_3, 1_4, 1_5, and 1_6) is subject to the light adjustment control, but a plurality of illumination devices may be simultaneously subject to the light adjustment control. In this case as well, to perform the light adjustment control of the illumination devices subject to the light adjustment control, the above-described light adjustment assistance control period may be provided for illumination devices not subject to the light adjustment control to set them in the light adjustment assistance control state (second mode).

### First Modification

In the above-described example of the embodiment, the light emission pattern (light adjustment state) in the light adjustment assistance control state (second mode) is stored in the storage 114 of each illumination device 1, but the present disclosure is not limited thereto and the light emission pattern (light adjustment state) in the light adjustment assistance control state (second mode) may be stored in the storage 223 of the control device 200.

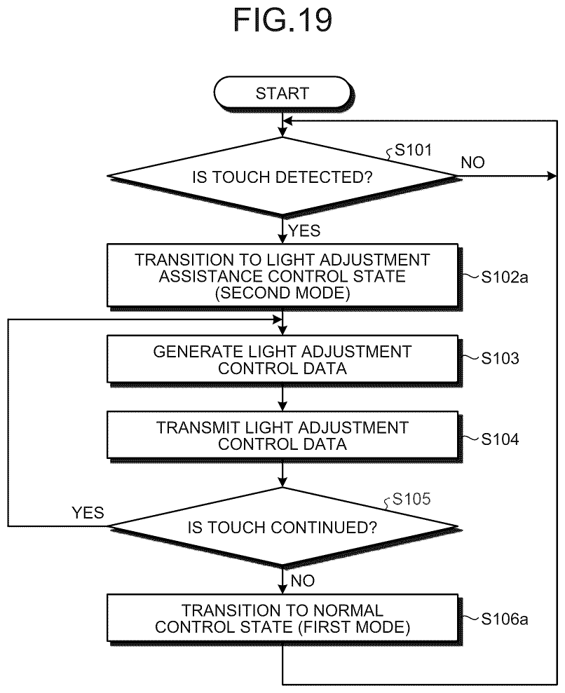

FIG. 19 is a flowchart illustrating an example of light adjustment control processing by the control device according to a first modification of the embodiment. Processing different from FIG. 15 of the above-described embodiment will be described below.

At step S101, in a case where a touch is detected in the data adjustment region TA (Yes at step S101), the control device 200 starts the light adjustment control of the illumination device 1 (1_3) subject to the light adjustment control. In this case, the control device 200 transmits light adjustment control data (for example, information on a predetermined light emission intensity with which turning-off or dimming is achieved) in accordance with the light emission pattern (light adjustment state) in the light adjustment assistance control state (second mode), which is stored in the storage 223, to the illumination devices 1 (1_1, 1_2, 1_4, 1_5, and 1_6) not subject to the light adjustment control, thereby causing the illumination devices 1 to transition to the light adjustment assistance control state (second mode) (step S102a).

At step S105, in a case where the touch is not continued in the data adjustment region TA (No at step S105), the control device 200 stops the light adjustment control of the illumination device 1 (1_3) subject to the light adjustment control. In this case, the control device 200 stops transmission of light adjustment control data (for example, information on a predetermined light emission intensity with which turning-off or dimming is achieved) to the illumination devices 1 (1_1, 1_2, 1_4, 1_5, and 1_6) not subject to the light adjustment control and transmits light adjustment control data (for example, information on a predetermined light emission intensity with which lighting is achieved) in accordance with the light emission pattern (light adjustment state) in the normal control state (first mode), thereby causing the illumination devices 1 to transition from the light adjustment assistance control state (second mode) to the normal control state (first mode) (step S106a).

Alternatively, after the elapse of a predetermined time (for example, 3 s) since stopping the light adjustment control of the illumination device 1 (1_3) subject to the light adjustment control, the control device 200 may stop transmission of light adjustment control data (for example, information on a predetermined light emission intensity with which turning-off or dimming is achieved) to the illumination devices 1 (1_1, 1_2, 1_4, 1_5, and 1_6) not subject to the light adjustment control and transmit light adjustment control data (for example, information on a predetermined light emission intensity with which lighting is achieved) in accordance with the light emission pattern (light adjustment state) in the normal control state (first mode), thereby causing the illumination devices 1 to transition from the light adjustment assistance control state (second mode) to the normal control state (first mode).

Thus, the same effects as in the above-described embodiment are obtained in the first modification as well.

### Second Modification

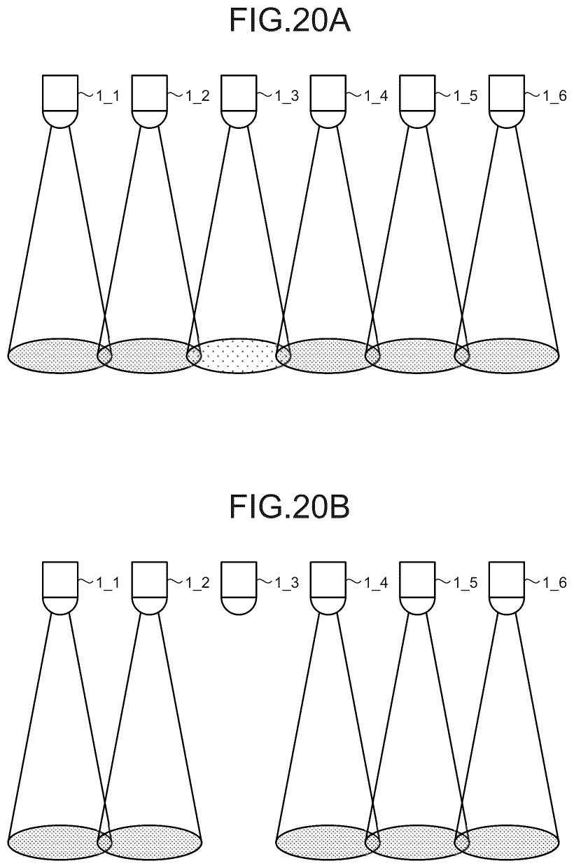

FIGS. 20A and 20B are conceptual diagrams for describing operation of each illumination device in light adjustment control of an illumination system according to a second modification of the embodiment. FIGS. 20A and 20B illustrate an example in which the illumination device 1_3 is subject to the light adjustment control as in the above-described embodiment.

In the second modification of the embodiment, the control device 200 repeatedly alternates, at predetermined intervals (for example, 0.5 s), a light adjustment control period (refer to FIG. 20A) in which the light adjustment control of the illumination device 1 (1_3) subject to the light adjustment control is performed and a turn-off period (refer to FIG. 20B) in which the illumination device 1 (1_3) subject to the light adjustment control is turned off. Thus, the irradiation area of light from the illumination device 1 (1_3) subject to the light adjustment control is easy to identify.

A dimming period in which the illumination device 1 (1_3) subject to the light adjustment control is dimmed relative to the light adjustment control period may be provided in place of the turn-off period in which the illumination device 1 (1_3) subject to the light adjustment control is turned off. Alternatively, neither the turn-off period in which the illumination device 1 (1_3) subject to the light adjustment control is turned off nor the dimming period in which the illumination device 1 (1_3) subject to the light adjustment control is dimmed relative to the light adjustment control period may be provided, and the light emission color in the light adjustment control period may be caused to be a light emission color (second light emission color) different from a light emission color (first light emission color) in the normal control state (first mode) in the normal light emission period.

The preferable embodiments of the present disclosure are described above, but the present disclosure is not limited to such embodiments. Contents disclosed in the embodiments are merely exemplary, and various kinds of modifications are possible without departing from the scope of the present disclosure. Any modification performed as appropriate without departing from the scope of the present disclosure belongs to the technical scope of the present disclosure.

What is claimed is:

1. An illumination system comprising a plurality of illumination devices each having a light adjustment function, wherein
each of the illumination devices has
a first mode in which all of the illumination devices are not subject to light adjustment control, and
a second mode in which another illumination device of the illumination devices is subject to the light adjustment control, and
in the second mode, the illumination device is controlled to be in a light adjustment state different from a light adjustment state in the first mode.

2. The illumination system according to claim 1, wherein each of the illumination devices is lit in the first mode and not lit in the second mode.

3. The illumination system according to claim 1, wherein each of the illumination devices is lit in the first mode and dimmed in the second mode relative to the first mode.

4. The illumination system according to claim 1, wherein each of the illumination devices is lit in a first light emission color in the first mode and lit in a second light emission color in the second mode, the second light emission color being different from the first light emission color.

5. The illumination system according to claim 1, wherein each of the illumination devices are configured to repeatedly alternates between a first light adjustment state and a second light adjustment state at predetermined intervals in the second mode.

6. The illumination system according to claim 5, wherein each of the illumination devices is lit in the second light adjustment state and lit in the first light adjustment state.

7. The illumination system according to claim 5, wherein each of the illumination devices is lit in the second light adjustment state and dimmed in the first light adjustment state relative to the second light adjustment state.

8. The illumination system according to claim 5, wherein each of the illumination devices is lit in a first light emission color in the second light adjustment state and lit in a second light emission color in the first light adjustment state, the second light emission color being different from the first light emission color.

9. The illumination system according to claim 1, further comprising a control device configured to perform the light adjustment control of the illumination devices, wherein
each of the illumination devices is configured to receive a light adjustment assistance control start command from the control device and make a transition from the first mode to the second mode.

10. The illumination system according to claim 9, wherein each of the illumination devices is configured to receive a light adjustment assistance control stop command from the control device and make a transition from the second mode to the first mode.

11. The illumination system according to claim 9, wherein each of the illumination devices is configured to transition from the second mode to the first mode after an elapse of a predetermined time since receiving a light adjustment assistance control stop command from the control device.

12. The illumination system according to claim 1, further comprising a control device configured to perform the light adjustment control of the illumination devices, wherein
when at least one of the illumination devices is subject to the light adjustment control and the light adjustment control of the illumination device is started, the control device causes another illumination device of the illumination devices different from the at least one of the illumination devices to transition from the first mode to the second mode.

13. The illumination system according to claim 12, wherein when the light adjustment control of the illumination device subject to the light adjustment control is stopped, the control device causes another illumination device of the illumination devices to transition from the second mode to the first mode.

14. The illumination system according to claim 12, wherein after an elapse of a predetermined time since stopping the light adjustment control of the illumination device subject to the light adjustment control, the control device causes another illumination device of the illumination devices to transition from the second mode to the first mode.

15. An illumination system comprising:
a plurality of illumination devices each having a light adjustment function; and
a control device configured to perform light adjustment control of the illumination devices, wherein
each of the illumination devices has
a first mode in which all of the illumination devices are not subject to the light adjustment control, and
a second mode in which another illumination device of the illumination devices is subject to the light adjustment control,
each of the illumination devices is lit in the first mode, and
when at least one of the illumination devices is subject to the light adjustment control and the light adjustment control of the at least one of the illumination devices is performed, the control device repeatedly alternates, at predetermined intervals, a light adjustment control period in which the light adjustment control is performed and a turn-off period in which the at least one of the illumination devices subject to the light adjustment control is not lit.

16. An illumination system comprising:
a plurality of illumination devices each having a light adjustment function; and
a control device configured to perform light adjustment control of the illumination devices, wherein
each of the illumination devices has
a first mode in which all of the illumination devices are not subject to the light adjustment control, and
a second mode in which another illumination device of the illumination devices is subject to the light adjustment control,
each of the illumination devices is lit in the first mode, and
when at least one of the illumination devices is subject to the light adjustment control and the light adjustment control of the at least one of the illumination devices is performed, the control device repeatedly alternates, at predetermined intervals, a light adjustment control period in which the light adjustment control is performed and a dimming period in which the at least one of the illumination devices subject to the light adjustment control is dimmed relative to the light adjustment control period.

17. The illumination system according to claim 1, wherein
each of the illumination devices is capable of controlling a distribution angle of light emitted from a light source as the light adjustment function, and
the distribution angle of the at least one of the illumination devices subject to the light adjustment control is controlled when the illumination devices not subject to the light adjustment control are in the second mode.
